(19) United States
(12) Patent Application Publication
(10) Pub. No.: US 2005/0166981 A1
(43) Pub. Date: Aug. 4, 2005

(54) Actuation system for fluid flow diverter

(75) Inventor: John Brotzman, Freeport, ME (US)

Correspondence Address: CHRIS A. CASEIRO, VERRILL DANA, LLP, ONE PORTLAND SQUARE, PORTLAND, ME, 04112-0586, US

(73) Assignee: Bachmann Industries, Inc., Auburn, ME (US)

(21) Appl. No.: 10/771,755

(22) Filed: Feb. 4, 2004

(51) Int. Cl. F16K 11/072

(52) U.S. Cl. 137/872

(57) ABSTRACT

An actuation system for causing movement of a fluid flow diverter. The actuation system includes a drive frame assembly, a crank arm assembly and a ball screw assembly working in combination as an electromechanical device suitable for movement of diverter devices of a wide range of sizes. The drive frame assembly is connected to the diverter. The crank arm assembly is attached to the diverter's diverting component, such as a damper flap. The crank arm assembly is connected to the ball screw assembly such that movement of the ball screw forces pivotal movement of the crank arm and, in turn, the diverter's diverting component. A variable speed motor causes linear movement of a ball screw along a fixed rod, with the crank arm assembly connected to the movable ball screw. A drive lockout assembly ensures that movement of the ball screw occurs only under controlled conditions.

### BACKGROUND OF THE INVENTION

1. Field of the Invention

The present invention relates to systems for moving fluids among a plurality of fluid flow pathways. More particularly, the present invention relates to devices for fluid flow diversion in industrial processes, including in power generating systems, but is not limited thereto. Still more particular, the present invention relates to the mechanisms for causing movement of such diversion devices.

2. Description of the Prior Art

Effective fluid flow transfer is an important aspect of many industrial processes. In the power generation industry in particular, the effective transfer of significant volumes of fluids impacts power generation productivity and the environment. Devices designed to ensure that such fluids move from one portion of the power generation plant to another when desired aid in maximizing productivity and minimizing adverse environmental impact. However, as power generation facilities and systems increase in size, the task of fluid diversion devices becomes increasingly harder.

It is well known in the power generation industry that boilers are employed to produce steam at high temperature and pressure. That steam is used to move turbines coupled to generators. Combustible fuels are used in combustion containers such as gas turbines (for oil, gas or other fluid fuels), or boiler combustion chambers fired by solid-fuel combustibles such as coal, wood, or other solid fuels to produce the heat necessary to generate the steam. Products of that fuel combustion exit the boiler at high temperatures and can include a variety of hazardous byproducts, dependent upon the type of fuel. The high-temperature combustion or exhaust gases exiting the combustion container may be exhausted to the atmosphere through a cooling stack, transferred to a secondary energy recovery system, or both in alternation under a schedule or as conditions warrant.

Although it is easy to state that the exhaust gases can be transferred from the combustion container to an exhaust stack or to secondary recovery, the process itself is not trivial. The ducts used to contain the exhaust gas and through which the exhaust gas passes from one portion of the system to the next are very large. Some may have dimensions on the order of 15 feet, 20 feet, and 30 feet or more. The entry and exit ports of the individual components and to which the ducts are attached are necessarily similarly sized. The means for regulating the flow of the exhaust gas through those ports from one system component to another must also be similarly sized. Such means are ordinarily referred to as diverters or dampers. Dampers are designed either to allow fluids to pass through a port or to block fluids from entering a port. For example, a damper may be used to block exhaust gas entering the exhaust stack while allowing it to pass through to the energy recovery means, or to block the exhaust gas from entering the energy recovery means and allowing it to enter the exhaust stack.

The most common types of dampers used in large-scale industrial processes are guillotine dampers, louver dampers, and flap dampers. The guillotine damper is a blade that is lowered or raised into or out of the fluid path. When raised out of the path, they provide little in the way of an obstruction, resulting in little pressure drop. When lowered to block the fluid path, they block fluid passage effectively. However, guillotine dampers require extensive space and a substantial support arrangement to allow sufficient blade travel and structural integrity. Further, the actuation systems associated with guillotine dampers are relatively complex and expensive. Moreover, because it is completely out of the fluid path when raised, it goes through significant thermal cycling that can result in damper warpage. Importantly, if fluid is to be diverted among three ports, such as with the exit from the turbine to either the exhaust stack or the energy recovery, it is necessary to employ at least two guillotine dampers, one each for at least two of the ports. Guillotine dampers are therefore not suitable in all circumstances.

Louver dampers are positioned within the duct and therefore do not require extra room to employ. Moreover, because they are positioned in the fluid path, they experience less thermal cycling than do guillotine dampers. On the other hand, because they do remain in the fluid path at all times, they produce substantial pressure drops that reduce operational efficiency. Further, they are potentially subject to significant contaminant impingement and fouling. The actuation mechanisms for louver dampers are complex and, in order to reduce excess leakage, supplemental cushion air may be required. Importantly, if fluid is to be diverted among three ports, such as with the exit from the turbine to either the exhaust stack or the energy recovery, it is necessary to employ at least two louver dampers, one each for at least two of the ports. Louver dampers are therefore not suitable in all circumstances.

Flap dampers incorporate advantages of guillotine and louver dampers without similar limitations. First, the blocking element of the flap damper, the flap, can be moved completely out of the fluid path, minimizing pressure drops, and can also substantially completely block a port when in the blocking position. Second, flap dampers do not require as much operational space to employ as is required for guillotine dampers. Third, the actuation means for flap dampers tend to be less complex than for guillotine and louver dampers. Finally, a single flap damper may be used to divert fluid among three ports. Therefore, a single flap damper may be employed to replace two guillotine dampers or two louver dampers, thereby reducing costs and maintenance requirements.

Flap dampers include a flap with sealing edges for positioning within a housing frame. The flap includes a first side that comes in contact with the fluid to be diverted, and a second side that remains outside of the fluid path. Typically, for very large flap dampers, a pair of pivot arms is attached to the second side of the flap. The pivot arms are connected to an actuation system that causes the movement of the pivot arms and thus, the movement of the flap between a first position and a second position. The type of actuation system employed to cause movement of the pivot arms is dependent upon the size of the flap. For relatively small flaps, electromechanical (EM) actuators are employed. For larger flaps, hydraulic actuators are used. The EM actuators include wormgears coupled to the actuation system, and a single speed motor for rotating the wormgear. The hydraulic actuators include one or a pair of hydraulic cylinders coupled to the actuation system. An example of an effective flap damper is the IsoFlap™ damper provided by Bachmann Industries of Auburn, Me. The Bachmann flap damper includes a toggle drive system coupled to the flap.

There are advantages and disadvantages associated with each of the existing EM and hydraulic actuators presently in use with flap dampers. The EM actuators operate at a single speed and must be operated very slowly due to necessarily high reduction ratios. They are therefore unsuitable in situations where relatively rapid opening or closing is required. In addition, existing EM actuators are not sufficiently strong to be used in large-scale applications, including in modern power generation systems. The hydraulic actuators have sufficient strength for use in large systems; however, they are very complex and expensive to install and maintain. It is therefore preferable to use EM actuators whenever possible.

What is needed is a flap damper actuation system capable of causing movement of dampers of any size. What is also needed is such a damper actuation system of minimal complexity and limited maintenance requirement. Further, what is needed is a damper actuation system that may be operated at variable speed selectable as a function of the fluid diversion conditions required.

### SUMMARY OF THE INVENTION

The present invention is a flap damper actuation system capable of causing movement of dampers of any size to cause the diversion of a fluid. The damper actuation system is of minimal complexity and may be operated at variable speed selectable as a function of the fluid diversion conditions required.

The damper actuation system is preferably used with a toggle drive arrangement such as is provided with the Bachmann Industries IsoFlap™ damper. The toggle drive includes a toggle tube affixed to the damper flap and coupled to the actuation system. Upon activation of the actuation system, the toggle tube is rotated from a first position to a second position, pivoting the damper flap from a first diversion position to a second diversion position. It is to be understood that the actuation system of the present invention may be employed with other types of structural means for joining the actuator and the damper flap together. However, the toggle tube is a lightweight device having minimal thermal impact while providing suitable structural integrity. The damper actuation system includes a ball screw assembly in combination with a crank arm and a variable frequency drive system to provide an electromechanical device capable of moving damper flaps that have heretofore only been moved by hydraulic actuators.

In one aspect of the invention, a system is provided for causing the movement of the moving component of a fluid flow diverter, the system including a drive frame assembly connectable to the diverter, a crank arm assembly connectable to the diverter's actuation system, a ball screw assembly connected to the drive frame assembly and including a ball screw connected to the crank arm assembly, the ball screw assembly configured to cause pivotal movement of the crank arm assembly, and a drive motor connected to the ball screw assembly to cause rotational movement of the ball screw. The ball screw assembly further includes a rotatable rod attached to the drive motor, which is preferably a variable speed motor. The ball screw attached around the rotatable rod such that as the drive motor rotates the rotatable rod, the ball screw moves linearly along the rotatable rod. The system also may include a drive lockout assembly connected between the drive motor and the ball screw assembly to regulate movement of the ball screw.

In another aspect of the invention with a flap damper diverter having a toggle tube attachment device to enable the flap, the system includes the drive frame assembly, crank arm assembly, and ball screw assembly as described above. The drive frame assembly includes a first frame plate and a second frame plate, the first frame plate and the second frame plate each including a toggle tube port for retaining the toggle tube therein. For such a diverter, the drive frame assembly further includes a pivot pin rotatably affixed to the first drive frame plate and the second drive frame plate, the pivot pin further rotatably connected to the ball screw assembly. Also, the crank arm assembly preferably includes a first crank arm plate, a second crank arm plate and a toggle tube bushing, wherein the toggle tube bushing retains the toggle tube therein, the first crank arm plate and the second crank arm plate each including at a first end thereof a bushing port for retaining therein the toggle tube bushing, and wherein the first crank arm plate and the second crank arm plate each includes at a second end thereof attachment pins for attaching the first crank arm plate and the second crank arm plate to the ball screw. Yet further, the ball screw assembly includes a rotatable rod attached to the drive motor, the ball screw attached around the rotatable rod such that as the drive motor rotates the rotatable rod, the ball screw moves linearly along the rotatable rod, and a support plate for rotatably retaining the rotatable rod thereon, and wherein the support plate includes at a first end thereof a stanchion with two ports for retaining therein the pivot pin of the drive frame assembly.

The details of one or more examples related to the invention are set forth in the accompanying drawings and the description below. Other features, objects, and advantages of the invention will be apparent from the description and drawings, and from the appended claims.

### BRIEF DESCRIPTION OF THE DRAWINGS

FIG. 1 is a simplified side view of a portion of a power generation system including a gas turbine, a heat recovery steam generator (HRSG), an exhaust stack and a diverter for diverting fluid flow from the turbine to either the HRSG or the exhaust stack, the diverter including the actuation system of the present invention.

FIG. 2 is a side view of the diverter including the actuation system of the present invention affixed to a toggle tube that is connected to a flap damper of the diverter system.

FIG. 3 is a top view of the diverter including the actuation system of the present invention affixed to the toggle tube.

FIG. 4 is a perspective view of the actuation system of the present invention shown enclosed.

FIG. 5 is a perspective view of the actuation system shown with the drive frame in partial phantom and affixed to a toggle tube.

FIG. 6 is a top view of the actuation system.

FIG. 7 is a side view of the actuation system.

FIG. 8 is a top view of the drive frame of the actuation system.

FIG. 9 is a side view of one of the drive frame plates of the drive frame of the actuation system.

FIG. 10 is an exploded view of the drive frame system of the actuation system of the present invention.

FIG. 11 is a plan view of the crank arm assembly of the actuation system.

FIG. 12 is an elevation view of a crank arm plate of the crank arm assembly.

FIG. 13 is an isometric view of the crank arm assembly.

FIG. 14 is a cross-sectional side view of the toggle tube bushing of the crank arm assembly.

FIG. 15 is a top view of the ball screw assembly of the actuation system.

FIG. 16 is a side view of the ball screw assembly.

FIG. 17 is an end view of the ball screw assembly.

FIG. 18 is a top view of the support plate of the ball screw assembly.

FIG. 19 is a side view of the support plate of the ball screw assembly.

FIG. 20 is an end view of the ball screw mounting block.

FIG. 21 is a perspective sectional view of the ball screw mounting block.

FIG. 22 is a side view of the rotatable rod of the ball screw shaft assembly.

FIG. 23 is a perspective section view of the hub seal assembly of the actuation system of the present invention.

FIG. 24 is an exploded view of a portion of the ball screw assembly showing the drive motor, coupling, mounting plate, and actuation sensors.

FIG. 25 is a detailed perspective view of the drive lockout assembly of the actuation system.

### DETAILED DESCRIPTION OF THE PREFERRED EMBODIMENT OF THE INVENTION

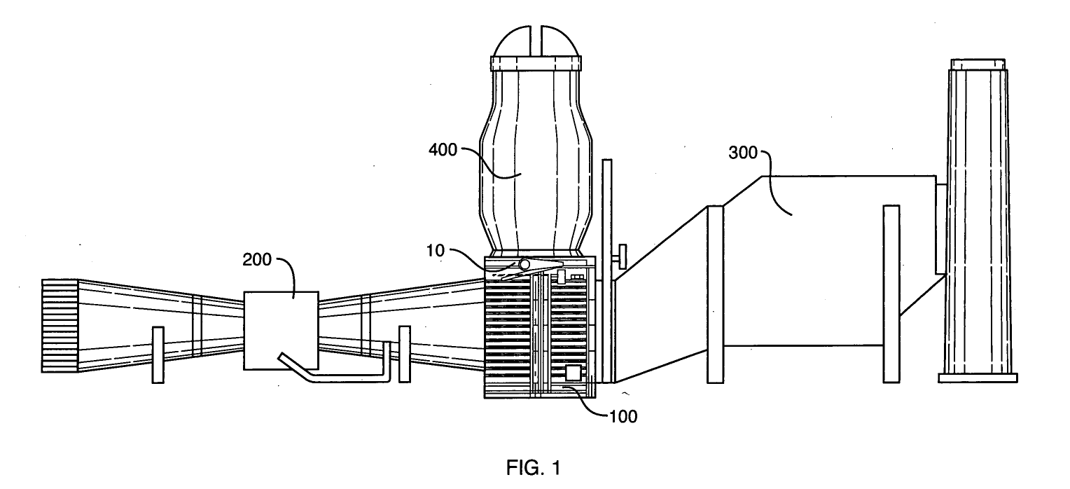

An actuation system 10 of the present invention is illustrated in the accompanying drawings. The actuation system 10 preferably forms part of a fluid flow diverter 100, such as the fluid flow diverter 100 shown in FIG. 1. The fluid flow diverter 100 of FIG. 1 is part of a fluid flow system of a power generation system including, among other primary components, a turbine 200, a HRSG 300, and an exhaust stack 400. In most cases, the fluid to be diverted is high temperature exhaust gas produced in a combustion container (not shown), is passed through the turbine 200, causing the turbine to move and turn a generator. A portion of the energy associated with the exhaust gas entering the turbine 200 is spent there, but the exhaust gas exiting the turbine may be tapped for additional energy. For that reason, many power generation systems include the HRSG 300 to recover additional energy from the exhaust gas for supplemental power generation. However, the HRSG 300 may not always be used and it is necessary to divert spent exhaust gas away from the HRSG 300 to the exhaust stack 400 for the turbine 200 to operate alone.

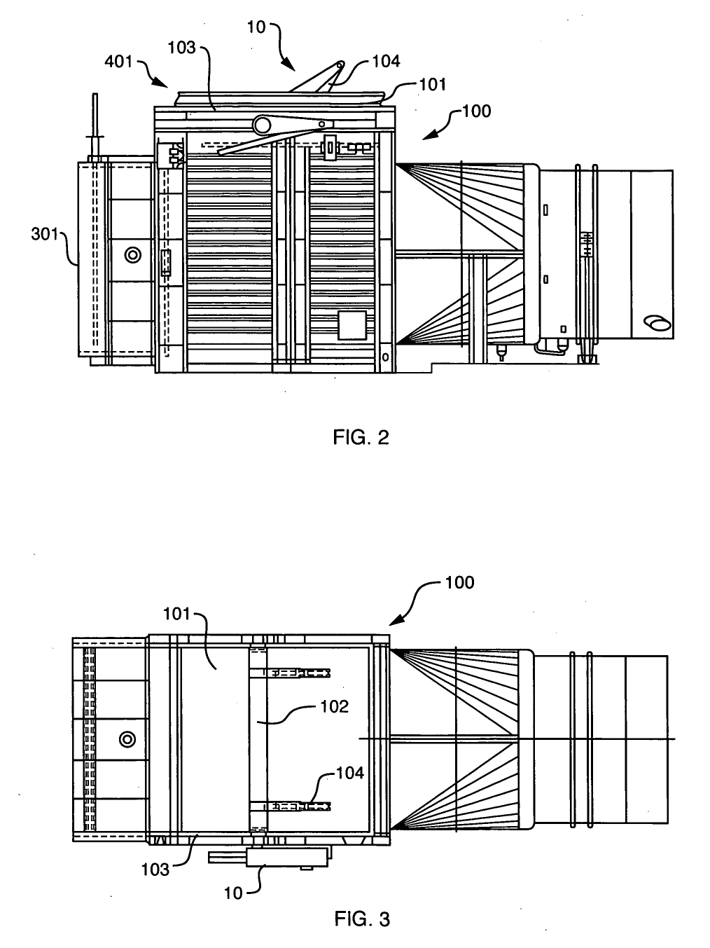

The diverter system 100 serves the purpose of enabling the switch of fluid flow from the turbine 200 to the HRSG 300 or to the exhaust stack 400. As illustrated in FIGS. 2 and 3, the diverter system 100 includes a damper flap 101, a link 104 attached to the damper flap 101 for its movement, and the actuator system 10 attached to the link 104. The actuator system 10 causes movement of the link 104 for the purpose of moving the damper flap 101 from a first position to a second position. For the purpose of discussion only, the first position may be one in which an HRSG entry port 301 of the HRSG 300 is blocked by the damper flap 101 and an exhaust stack entry port 401 of the exhaust stack 400 is left open. In the second position, the HRSG entry port 301 is left open, and the damper flap 101 blocks the exhaust stack port 401.

As the primary components of the power generation system increase in size and are designed to operate with tighter functional requirements, the demands on the diverter system 100 have increased. As previously indicated, it is desired to have larger damper flaps 101 that may be controlled to move over a range of movement rates. It is also of interest to be cost effective. For cost effectiveness, the actuation system 10 of the present invention is an electromechanical system rather than a hydraulic system. However, unlike electromechanical actuation systems of the past, the actuation system 10 is capable of moving very large damper flaps over a selectable range of movement rates. This is achieved using a ball screw movement element and a variable drive motor for movement of the ball screw. With continuing reference to FIGS. 2 and 3, the actuation system 10 is affixed to link 104 that is preferably a toggle tube 102 affixed to a back side 103 of the damper flap 101.

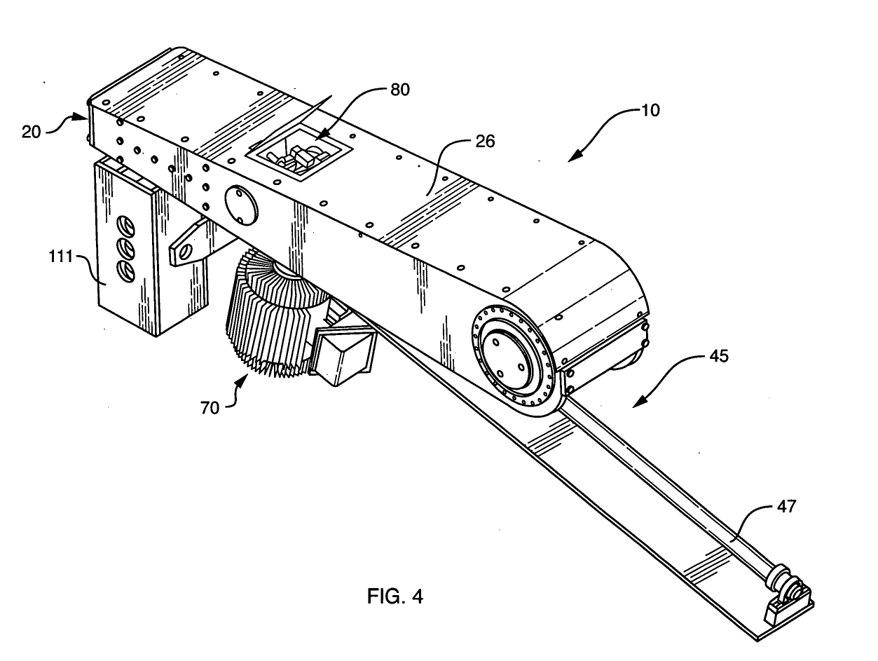

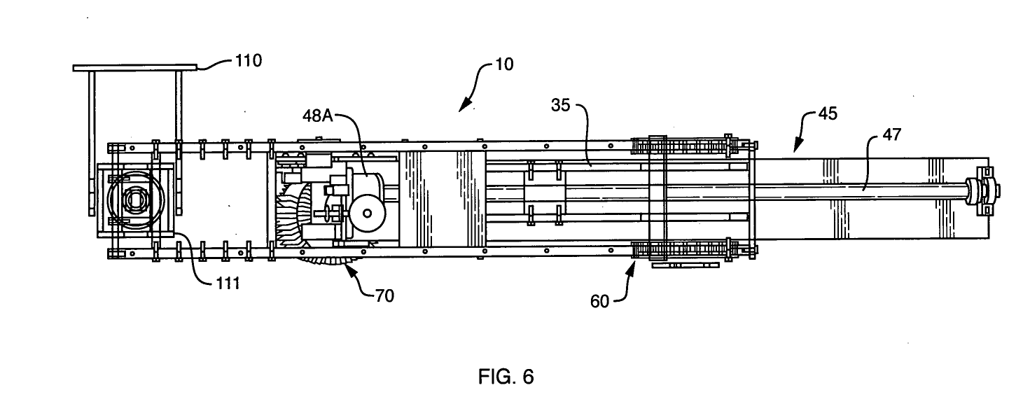

As illustrated in FIGS. 4-7, the actuation system 10 includes a drive frame assembly 20, a crank arm assembly 35, a ball screw assembly 45, a hub seal assembly 60, a drive motor 70, and a drive lockout assembly 80. The drive frame assembly 20 is the primary structural element of the actuation system 10. It substantially defines the dimensions of the actuation system 10 and establishes the connections between the toggle tube 102 and the ball screw assembly 45 for the purpose of causing movement of the damper flap 101. The crank arm assembly 35 is connected to the ball screw assembly 45 and its arrangement forces the rotation of the toggle tube 102. The ball screw assembly 45 includes a ball screw 46 that rides on a rotatable rod 47. The crank arm assembly 35 moves with the movement of the ball screw 46 along the rotatable rod 47. The hub seal assembly 60 secures the toggle tube 102 to the driver frame assembly 20 in a manner that allows smooth rotation of the toggle tube 102 upon movement of the crank arm assembly 35. The drive motor 70 is a variable speed motor and is connected to a gearbox 48A of the ball screw assembly 45 for the purpose of causing the rotation of the rotatable rod 47 at selectable rates. The drive lockout assembly 80 is connected to the gearbox 48A and arranged to ensure that the rotatable rod 47 will only move under controlled conditions. It is to be noted that the toggle tube 102 is preferably a solid drive shaft attached to a hollow tube.

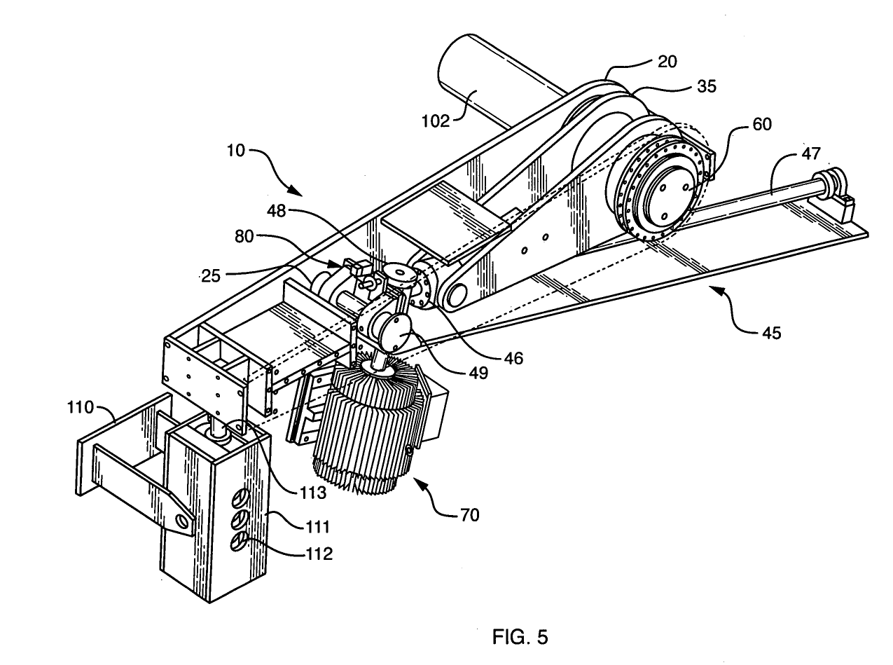

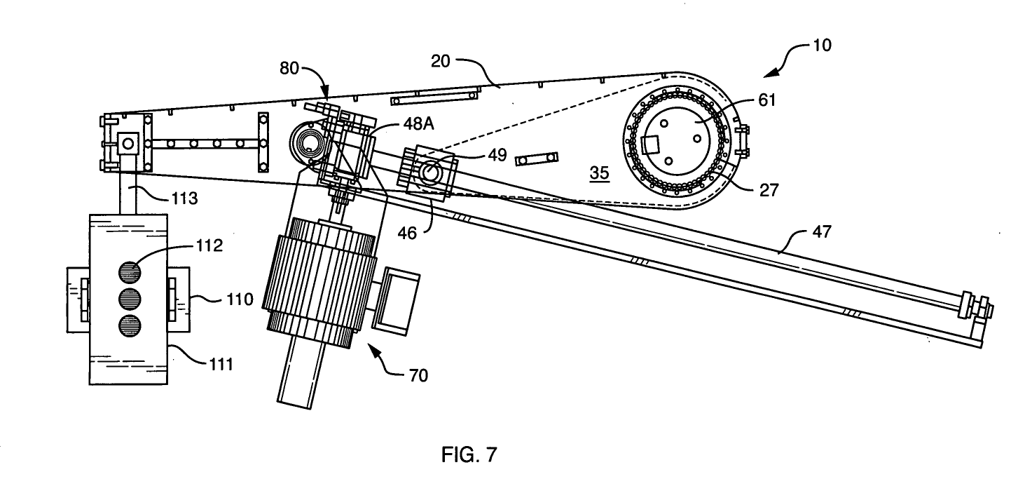

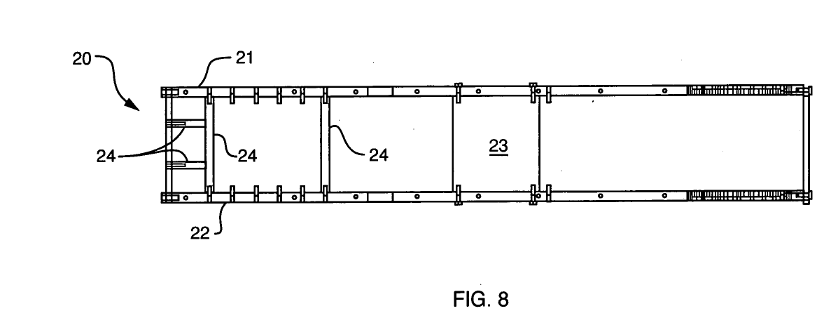

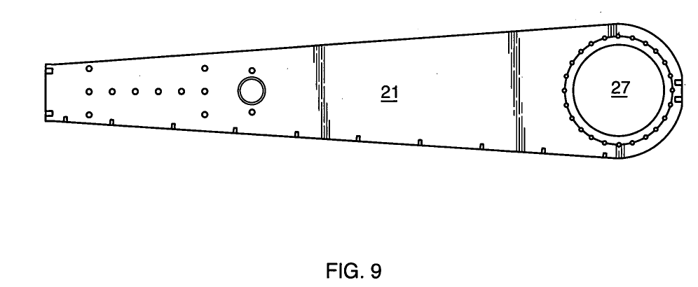

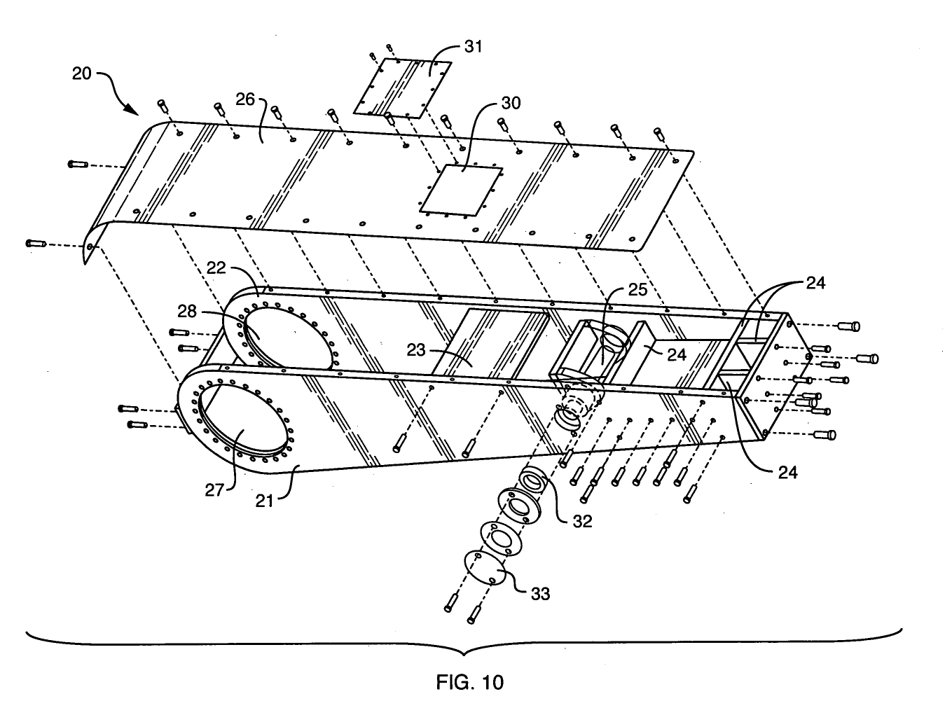

As shown in FIGS. 5-7, the drive frame assembly 20 may be affixed to a structural member of the diverter 100 with drive frame assembly attachment plate 110. The attachment plate 110 is rigidly affixed to spring assembly 111 having therein a plurality of springs 112 for retaining therein spring rod 113. The spring rod 113 is affixed to the drive frame assembly 20. The drive frame attachment assembly including the spring assembly 111 enables pivotal movement of the actuation system 10 by way of the drive frame assembly 20 during operation of the actuation system 10 and accommodates thermal expansion or contraction of the diverter 100, the actuation system 10, or both. 10461 As illustrated in FIGS. 8-10, the drive assembly 20 includes a first drive frame plate 21, a second drive frame plate 22, a frame connection plate 23, reinforcement plates 24, a pivot pin 25, and a frame cover plate 26. The first drive plate 21 includes at a first end thereof a first toggle tube port 27 and the second drive plate 22 includes at a first end thereof a second toggle tube port 28 capped by the hub seal assembly 60. The toggle tube 102 passes through the first toggle tube port 27, a portion of the crank arm assembly 35, and the second toggle tube port 28, where it is captured by the hub seal assembly 60 to be described herein. The toggle tube 102 is rotatably retained to the drive frame assembly 20 and permitted to spin on bearings 29 (shown in FIG. 7) of the first toggle tube port 27 and second toggle tube port 28. The frame cover plate 26 includes a maintenance port 30 positioned over the drive lockout assembly 80 for maintenance access thereof. Port cover 31 covers the maintenance port 30. The pivot pin 25 is rotatably connected to the first drive frame plate 21 and the second drive frame plate 22 through bushings 32 and caps 33. The pivot pin 25 is captured by and connected to the ball screw assembly 45. The pivot pin 25 enables pivotal movement of the ball screw assembly 45, rod 47, first crank arm retaining pin 48, drive lockout assembly 80, and the drive motor 70 with respect to the position of the drive frame assembly 20 as the ball screw assembly 45 moves the toggle tube 102 from one position to another.

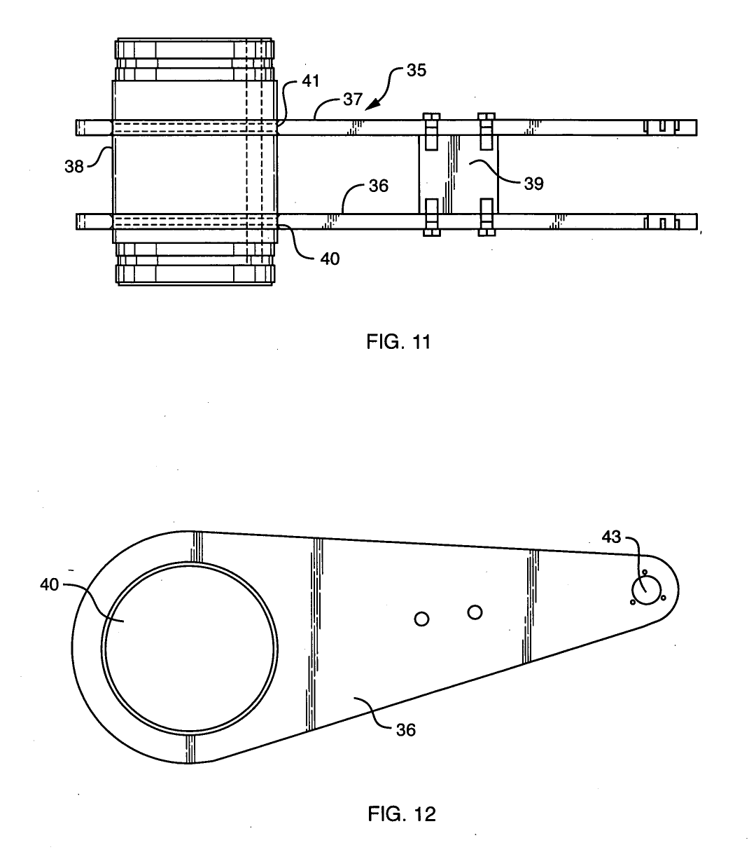

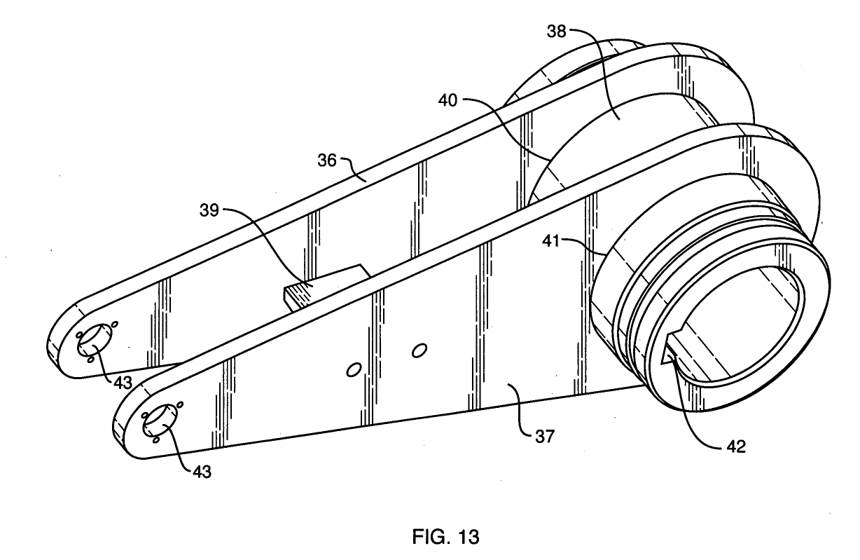

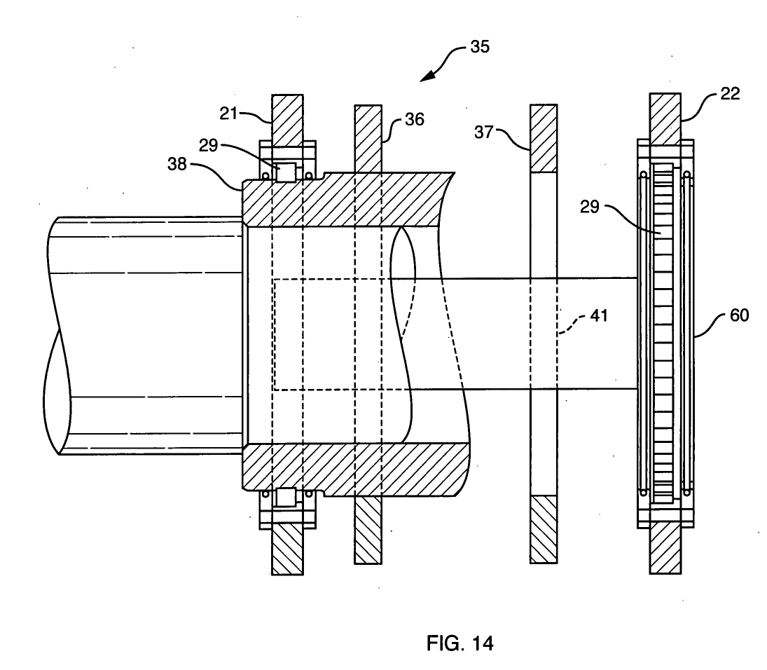

With reference to FIGS. 11-14, the crank arm assembly 35 includes a first crank arm plate 36, a second crank arm plate 37, drive hub 38, and reinforcement plate 39. The first crank arm plate 36 includes at a first end thereof a first bushing port 40 for receiving the drive hub 38, and the second crank arm plate 37 includes at a first end thereof a second bushing port 41 for receiving and retaining the drive hub 38. The drive hub 38 includes a keyway 42 cut into it for retaining and fixing the crank arm assembly 35 to the solid drive shaft of the toggle tube 102. The first crank arm plate 36 and the second crank arm plate 37 each includes at a second end thereof a receiving port 43 for retaining therein a crank arm retaining pin 48, 49 of the ball screw assembly 45 to affix the crank arm assembly 35 to the ball screw assembly 45. The toggle tube bushing 38 is affixed to the crank arm assembly 35 at ports 40 and 41 such that when the ball screw 46 of the ball screw assembly 45 moves, the first crank arm plate 36 and the second crank arm plate 37 pivot at the second end thereof and the first end thereof moves upwardly or downwardly dependent upon the direction of movement of the ball screw 46. The drive frame assembly 20 remains substantially in place as the toggle tube bushing 38 spins on the bearings 29 in the first toggle tube port 27 and the second toggle tube port 28 of the drive frame assembly 20.

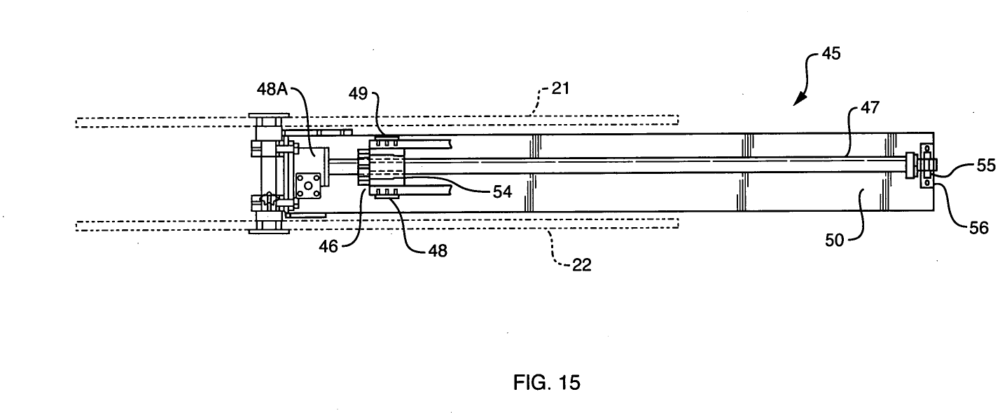

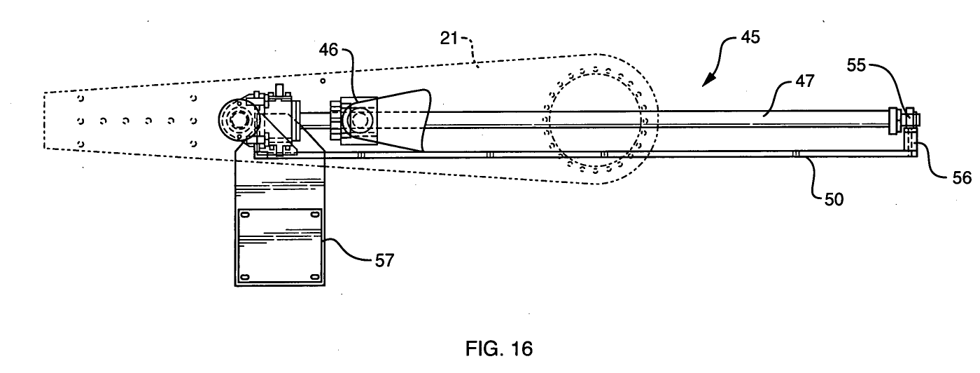

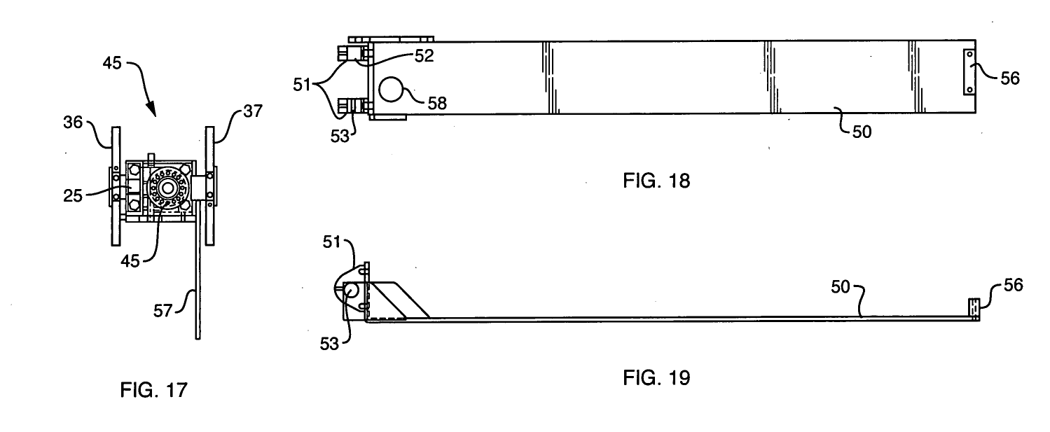

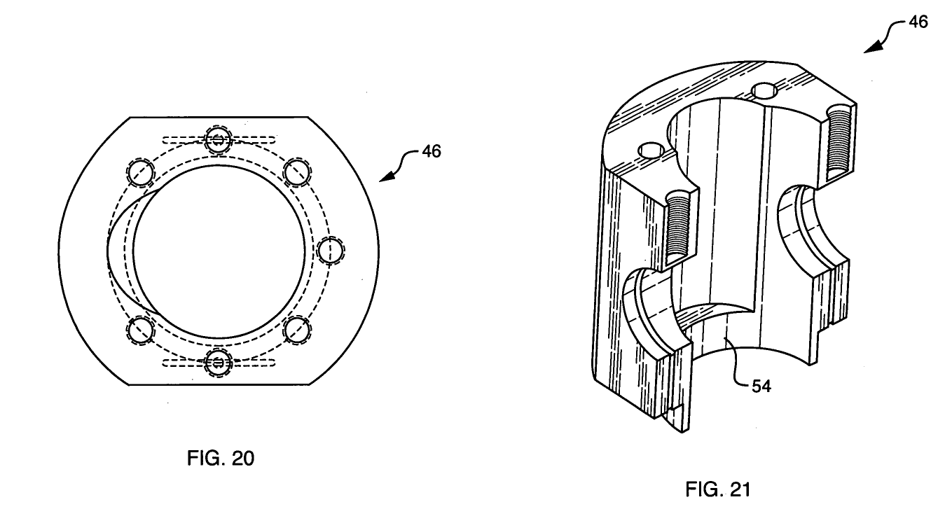

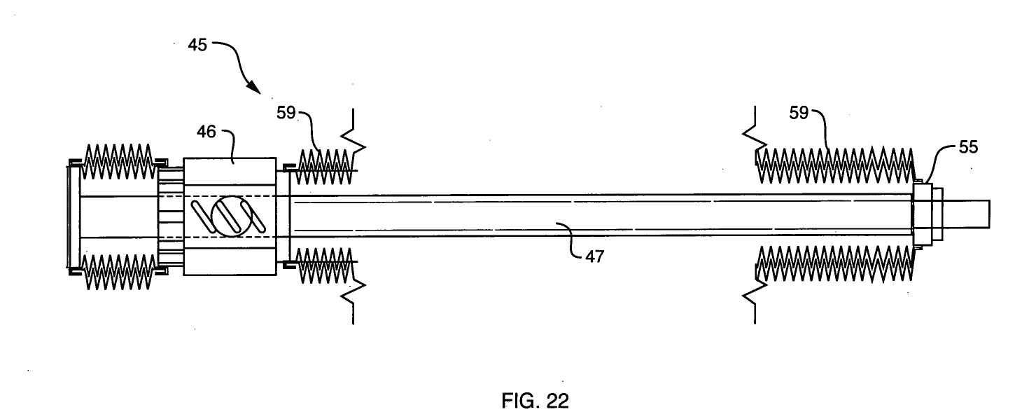

FIGS. 15-22 illustrate details of the ball screw assembly 45. The ball screw assembly 45 is arranged to cause the movement of the crank arm assembly 35 that is connected to the toggle tube 102 by way of drive hub 38. The ball screw assembly 45 includes the ball screw nut 46, the rotatable rod 47, first crank arm retaining pin 48, second crank arm retaining pin 49, and support plate 50. The support plate 50 includes stanchion 51 with stanchion ports 52 and 53 for retaining therein pivot pin 25 of the drive frame assembly 20. The ball screw assembly 45 is configured to pivot about the pivot pin 25 when the ball screw nut 46 moves. The ball screw nut 46 is a commercially available ball screw nut, such as ball screw model 50-BSJ provided by Nook Industries of Ohio. The ball screw nut 46 includes protrusions 54 for recirculating the ball bearings in the ball screw nut 46. As the threaded rotatable rod 47 rotates, the ball screw nut 46 moves along the rod 47 and, because it is connected to the crank arm assembly 35, it forces movement of the crank arm assembly 35. The rotatable rod 47 is rotatably affixed at a first end thereof to the gearbox 48A and then to the drive motor 70 through a universal joint of the lockout assembly 80. A second end of the rotatable rod 47 is rotatably retained in rod bearing 55. The rod bearing 55 is affixed to a second end of the support plate 50 by a support plate stanchion 56. The ball screw assembly 45 further includes a drive motor support plate 57 affixed to a second end of the support plate 50 such that as the ball screw assembly 45 pivots about pivot pin 25 of the drive frame assembly 20, so, too, does the drive motor 70 that is attached to the drive motor support plate 57. The support plate 50 includes drive motor bushing port 58 through which a drive shaft of the drive motor 70 is connected to the rotatable rod 47 and the drive lockout assembly 80. Rotatable rod boots 59 provide sealing protection of the rotatable rod 47 and can expand or contract to conform to the movement of the ball screw 46 along the rotatable rod 47. The rod boots 59 are preferably fabricated of an elastomer, but not limited thereto.

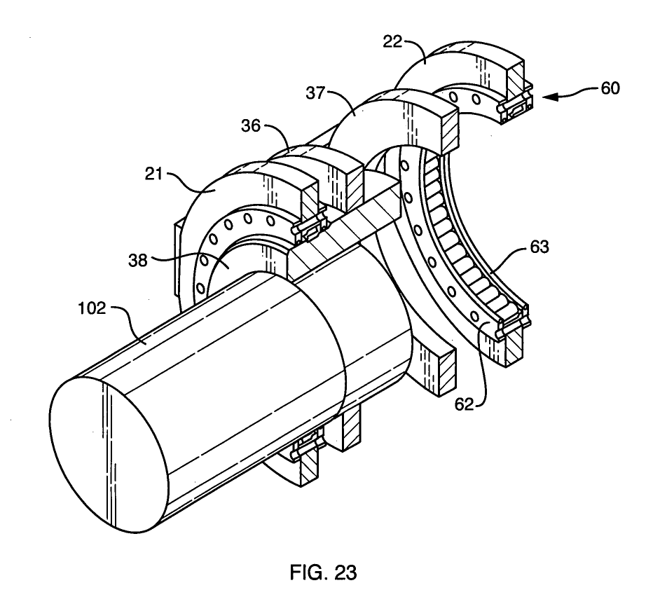

With reference to FIGS. 7, 10, and 23, the hub seal assembly 60 includes hub cap 61 and inner bearing retainer 62 with bearings 29 within the second toggle tube port 28 of the drive frame assembly 20. The hub cap 61 and inner bearing retainer 62 capture and retain the crank arm assembly 35.

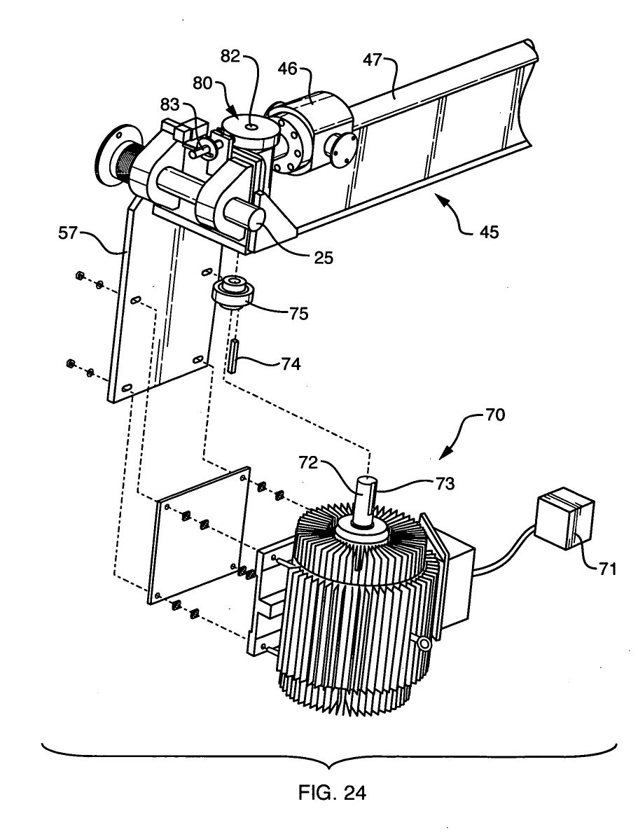

As illustrated in FIG. 24, the drive motor 70 is affixed to the ball screw assembly 45 at drive motor attachment plate 57. The drive motor 70 is a variable speed drive motor such as model number MM410 available from Siemens of Germany. The size and drive capability of the drive motor 70 is dependent upon the size of the damper flap 101 to be moved and the desired rate of movement. A drive motor control panel 71 with control circuitry that may be adjusted manually or automatically, including by remote control such as wired or wireless signal exchange, to regulate the rate of rotation of the motor's rotary drive shaft 72. The control panel 71 preferably includes control functions for operation of the actuation system 10 of the diverter 100, remotely or locally, as well as control of other functions including, for example seal air fan control. Starters for the drive motor 70 may be located either adjacent to or remote from the drive motor 70. A programmable microprocessor may be employed to control at least the variable frequency operation of the driver motor 70, as well as other systems including, for example, any fans or hydraulic components.

With continuing reference to FIG. 24, the drive shaft 72 includes shaft key way 73 for receiving key 74 that is retained in motor shaft coupling 75. The motor shaft coupling 75 is connected to the gearbox 48A such that its rotation on operation of the drive motor 70 causes variable rotation of the rotatable rod 47 and, thereby, linear movement of the ball screw 46 along the rotatable rod 47.

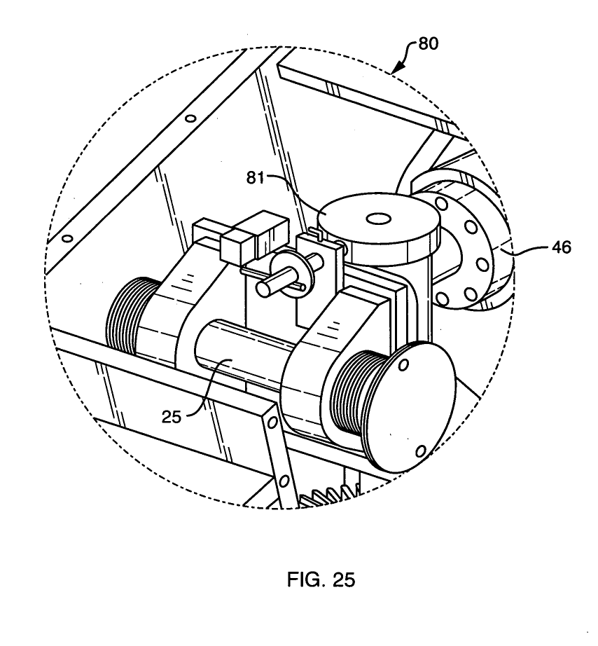

As illustrated in FIG. 25, the drive lockout assembly 80 includes locking disk 81 connected to the gearbox shaft 82. The drive lockout assembly 80 further includes a pin 83 retained to mounting plate 51 to prevent rotation of gearbox shaft 82 and drive motor 70 when inserted into a receiving hole of locking disk 81. This prevents operation of the drive assembly 20 for safety lockout purposes. Switch 84 senses the location of pin 85 and reports lockout status to the control system at control panel 71.

The combination of the drive frame assembly 20, the crank arm assembly 35, the ball screw assembly 45, and the drive motor 70 provide an electromechanical system for actuation of a flap damper of any size at a selectable range of movement rates. It is to be understood that while the actuation system 10 may be sized and configured to deploy a single system 10 to actuate a damper flap such as damper flap 101, it is to be understood that two actuation systems may be deployed, one at each end of the toggle tube 102. One may act as a redundant system or they may be operated in combination, provided they are appropriately synchronized. It is also to be understood that the actuation system 10 may be modified at the drive frame assembly 20 to accommodate other forms of connections to the diverter flap 101. Further, the drive assembly 20 may be directly coupled to the damper flap 101 by way of its pivot shaft without a toggle link of the type described in regard to the preferred embodiment of the invention. It is further to be understood that the actuation system 10 may be employed with other forms of fluid diversion arrangements including, but not limited to, water and other liquid movement systems, chemical process systems, and any form of gas flow systems, including over a wide range of temperature conditions. The materials used to fabricate the various components of the actuation system 10 may be selected as a function of the particular operation within which it is deployed. However, non-corrosive, high temperature metals, such as stainless steel, may be preferred in environments such as power generation systems.

While the present invention has been described with particular reference to certain embodiments of the separation system, it is to be understood that it includes all reasonable equivalents thereof as defined by the following appended claims.

1. A diverter actuation system for causing the movement of a diverter having a diverter drive, the actuation system comprising:
a) a drive frame assembly connectable to the diverter;
b) a crank arm assembly connectable to the diverter drive;
c) a screw assembly connected to the drive frame assembly and including a screw connected to the crank arm assembly, the screw assembly configured to cause pivotal movement of the crank arm assembly; and
d) a drive motor connected to the screw assembly to cause rotational movement of the screw.

2. The actuation system as claimed in claim 1 wherein the screw assembly further includes a rotatable rod attached to the drive motor, and wherein the screw is a ball screw attached around the rotatable rod such that as the drive motor rotates the rotatable rod, the ball screw moves linearly along the rotatable rod.

3. The actuation system as claimed in claim 1 wherein the drive motor is a variable frequency motor.

4. The actuation system as claimed in claim 1 further comprising a drive lockout assembly connected between the drive motor and the screw assembly to regulate movement of the screw.

5. The actuation system as claimed in claim 1 wherein the diverter drive is a toggle tube, the drive frame assembly including a first frame plate and a second frame plate, the first frame plate and the second frame plate each including a toggle tube port for retaining the toggle tube therein.

6. The actuation system as claimed in claim 5 wherein the drive frame assembly further includes a pivot pin rotatably affixed to the first drive frame plate and the second drive frame plate, the pivot pin further rotatably connected to the screw assembly.

7. The actuation system as claimed in claim 6 wherein the crank arm assembly includes a first crank arm plate, a second crank arm plate and a toggle tube bushing, wherein the toggle tube bushing retains the toggle tube therein, the first crank arm plate and the second crank arm plate each including at a first end thereof a bushing port for retaining therein the toggle tube bushing, and wherein the first crank arm plate and the second crank arm plate each includes at a second end thereof attachment pins for attaching the first crank arm plate and the second crank arm plate to the screw.

8. The actuation system as claimed in claim 7 wherein the screw assembly further includes a rotatable rod attached to the drive motor, and wherein the screw is a ball screw attached around the rotatable rod such that as the drive motor rotates the rotatable rod, the ball screw moves linearly along the rotatable rod.

9. The actuation system as claimed in claim 8 wherein the screw assembly further includes a support plate for rotatably retaining the rotatable rod thereon, and wherein the support plate includes at a first end thereof a stanchion with two ports for retaining therein the pivot pin of the drive frame assembly.

10. The actuation system as claimed in claim 9 further comprising a hub seal assembly for rotatably retaining the toggle tube to the drive frame assembly.

11. The actuation system as claimed in claim 10 further comprising a drive lockout assembly connected between the drive motor and the screw assembly to restrict movement of the ball screw.
